(19) United States
(12) Patent Application Publication
(10) Pub. No.: US 2025/0297910 A1
(43) Pub. Date: Sep. 25, 2025

(54) PRESSURE MEASUREMENT ASSEMBLY AND PRESSURE SENSOR

(71) Applicant: WUHAN FINEMEMS INC., Wuhan (CN)

(72) Inventors: Xiaoping WANG, Wuhan (CN); Dengfeng WU, Wuhan (CN); Fanliang LI, Wuhan (CN); Wan CAO, Wuhan (CN); Bing LI, Wuhan (CN); Tao SHI, Wuhan (CN)

(73) Assignee: WUHAN FINEMEMS INC., Wuhan (CN)

(21) Appl. No.: 19/233,313

(22) Filed: Jun. 10, 2025

Related U.S. Application Data
(63) Continuation of application No. PCT/CN2023/089940, filed on Apr. 21, 2023.

(30) Foreign Application Priority Data
Dec. 13, 2022 (CN) 202211619057.0

(51) Int. Cl. G01L 19/00; G01L 9/00

(52) U.S. Cl. CPC G01L 19/0038; G01L 9/0041

(57) ABSTRACT

A pressure measurement assembly includes a pressure connector provided with a pressure channel extending longitudinally and a pressure sensitive head. The longitudinal distal side of the pressure sensitive head is recessed inward to form a connecting tube with a sensing cavity facing the distal end, and the longitudinal proximal side of the pressure sensitive head is correspondingly formed with an elastic diaphragm. The longitudinal proximal side of the elastic diaphragm is provided with a pressure measurement circuit, and the proximal end of the connecting tube is sealed and connected to the pressure connector so that the proximal end of the pressure channel is in fluid communication with the sensing cavity. The proximal end of the connecting tube is welded to the pressure connector.

### CROSS-REFERENCE TO RELATED APPLICATIONS

The present application is a continuation of International Application No. PCT/CN2023/089940, filed on Apr. 21, 2023, which claims priority to Chinese Patent Application No. 202211619057.0, filed on Dec. 13, 2022. The disclosures of the above-mentioned applications are incorporated herein by reference in their entireties.

### TECHNICAL FIELD

The present application relates to the technical field of sensor, and in particular to a pressure measurement assembly and a pressure sensor.

### BACKGROUND

A pressure sensor using a pressure sensitive head measures pressure by introducing pressure fluid on one side of a metal diaphragm and setting a Wheatstone bridge consisting of a strain gauge or thick film piezoresistors on the other surface.

In Chinese Application Publications CN112857635A and CN115406565A, the pressure diaphragm is integrally connected with the pressure interface, which causes the assembly stress when the pressure interface is connected to the pipe or container to be measured to be transmitted to the pressure diaphragm, resulting in deviation in the measurement result.

The statements in this section merely provide background information related to the present application and may not constitute prior art.

### SUMMARY

The present application provides a pressure measurement assembly and a pressure sensor to improve the adverse effects of assembly stress on measurement results.

To achieve the above-mentioned purpose, the present application provides the following technical solutions. A pressure measurement assembly includes a pressure connector provided with a pressure channel extending longitudinally, and a pressure sensitive head. A longitudinal distal side of the pressure sensitive head is recessed inwardly to form a connecting tube, and the connecting tube is provided with a sensing cavity facing the distal end. A longitudinal proximal side of the pressure sensitive head is correspondingly formed with an elastic diaphragm, and a pressure measurement circuit is provided at a surface of a longitudinal proximal side of the elastic diaphragm. A proximal end of the connecting tube is sealedly connected to the pressure connector so that a proximal end of the pressure channel is in fluid communication with the sensing cavity, and the proximal end of the connecting tube is welded to the pressure connector.

In an embodiment, a longitudinal proximal end of the pressure connector is configured to protrude outward laterally to form a flange, and a proximal end portion of the pressure connector is configured to protrude outward laterally to form a support connection ring. The connecting tube is fitted on the flange and is supported and welded to the support connection ring. The flange, the support connection ring and the connecting tube are enclosed to form an annular cavity.

In an embodiment, an inner diameter of the proximal end of the pressure channel is configured to gradually expand to form a trumpet-shaped bell mouth.

In an embodiment, a connecting pipe is provided at a distal end of the pressure connector for connecting to a container or a pipeline to be measured.

In an embodiment, a concave or straight circumferential positioning portion is provided at a side of the pressure connector.

The present application further provides a pressure sensor. The pressure sensor includes a pressure measurement assembly including a pressure connector and a pressure sensitive head, a housing including a cylindrical shell extending longitudinally and an end plate sealing a longitudinal proximal end of the cylindrical shell, a terminal block fixedly connected to the end plate, a mounting base and a signal processing assembly provided in the mounting cavity, and a plurality of electrical connectors. A longitudinal distal side of the pressure sensitive head is recessed inwardly to form a connecting tube, and the connecting tube is provided with a sensing cavity facing the distal end. A longitudinal proximal side of the pressure sensitive head is correspondingly formed with an elastic diaphragm, and a pressure measurement circuit is provided at a surface of a longitudinal proximal side of the elastic diaphragm. A proximal end of the connecting tube is sealedly connected to the pressure connector so that a proximal end of the pressure channel is in fluid communication with the sensing cavity, and the proximal end of the connecting tube is welded to the pressure connector. A distal end of the cylindrical shell is sealedly connected to the pressure connector. The terminal block, the housing and the pressure connector are enclosed together to form a mounting cavity. The signal processing assembly is provided at the mounting base and is electrically connected to the pressure measurement circuit. One end of the electrical connector is configured to pass through the terminal block and the end plate inwardly and is then electrically connected to the signal processing assembly.

In an embodiment, the signal processing assembly includes a transverse plate, a first flexible plate, a longitudinal plate, a second flexible plate and a first conductive connection portion connected in sequence. The transverse plate, the longitudinal plate and the first conductive connection portion are provided in sequence from near to far. The first conductive connection portion is electrically connected to the pressure measurement circuit.

In an embodiment, the mounting base is configured to extend longitudinally. A side of the mounting base is recessed inward to form a receiving slot for receiving the longitudinal plate, and a top plate and a semicircular bottom plate are provided opposite to each other at a proximal end and a distal end of the mounting base. The transverse plate is supported and fixed at a proximal surface of the top plate, and the bottom plate is partially blocked at a proximal end of a pressure cylinder. A distal end of the pressure cylinder is pressed against a support step formed on the pressure connector. At least one first buckle clamped on the longitudinal plate is provided at each of lateral sides of the receiving slot.

In an embodiment, a side of the bottom plate is provided with a clearance notch extending to the bottom plate for the second flexible plate to pass through. A second flexible plate arrangement slot is provided at a proximal side of the bottom plate and is laterally in fluid communication with the clearance notch.

In an embodiment, a disassembly hole extending in a parallel direction to the second flexible plate arrangement slot is provided at a side wall of the pressure cylinder, and the disassembly hole is configured to extend to a bottom of the receiving slot.

In an embodiment, a first flexible board arrangement slot provided at an edge of the top plate is configured to extend longitudinally and is in fluid communication with the receiving slot toward the distal end, and the first flexible board arrangement slot and the clearance notch are provided at the same position in a circumferential direction of the mounting base. At least two rivet columns are provided at a proximal end of the top plate, and the rivet columns toward the proximal end are riveted to corresponding rivet holes opened on the transverse plate.

In an embodiment, a plurality of fourth conductive connection portions are provided on a proximal surface of the transverse plate. The electrical connector is an elastic member. A distal end of the electrical connector is passed through the terminal block and the end plate and then is configured to electrically contact the fourth conductive connection portions.

In an embodiment, the electrical connector is provided with two sections of conductive springs with different coil outer diameters, and a conical transition section is provided between the two sections of the conductive springs. A retaining cavity for accommodating the conductive springs is correspondingly provided at the terminal block, and is provided with a compression portion. The compression portion is configured to press the transition section toward the distal side against the fourth conductive connection portion.

In an embodiment, a second buckle for clamping the metal base is provided at the mounting base.

In an embodiment, a longitudinal proximal end of the pressure connector is configured to protrude outward laterally to form a flange, and a proximal end portion of the pressure connector is configured to protrude outward laterally to form a support connection ring. The connecting tube is fitted on the flange, and is supported and welded to the support connection ring. The flange, the support connection ring and the connecting tube are enclosed to form an annular cavity.

In an embodiment, a stress isolation slot is provided between the support step and the support connection ring.

In an embodiment, an inner diameter of the proximal end of the pressure channel is configured to gradually expand to form a trumpet-shaped bell mouth.

In an embodiment, a connecting pipe is provided at a distal end of the pressure connector for connecting to a container or a pipeline to be measured.

In an embodiment, a concave or straight circumferential positioning portion is provided at a side of the pressure connector.

In an embodiment, a proximal end of the terminal block is provided with a plurality of first material reduction blind holes extending longitudinally, and a side of the mounting base facing away from the receiving slot is provided with a plurality of second material reduction blind holes.

The pressure measurement assembly and the pressure sensor of the present application can improve the adverse effect of assembly stress on the measurement result.

### BRIEF DESCRIPTION OF THE DRAWINGS

FIG. 1 is a front view of a pressure sensor according to an embodiment of the present application.

FIG. 2 is a cross-sectional view of a pressure sensor according to an embodiment of the present application along the line A-A shown in FIG. 1.

FIG. 3 is a three-dimensional view of a pressure sensor according to an embodiment of the present application (with the housing hidden).

FIG. 4 is a three-dimensional view of a signal processing assembly according to an embodiment of the present application.

FIG. 5 is a three-dimensional view of a mounting base according to an embodiment of the present application.

FIG. 6 is a three-dimensional view of a mounting base from another perspective according to an embodiment of the present application.

### DETAILED DESCRIPTION OF THE EMBODIMENTS

The technical solution of the present application will be clearly and completely described below in conjunction with the accompanying drawings. The following embodiments are exemplary and are only used to explain the present application, and cannot be interpreted as limiting the present application. In the following description, the same symbols are used to represent the same or equivalent elements, and repeated descriptions are omitted.

In the description of the present application, it should be understood that the orientations or positional relationships indicate by the terms “upper”, “lower”, “inside”, “outside”, “left”, “right”, etc. are the orientations or positional relationships based on the accompanying drawings, or are the orientations or positional relationships in which the product is conventionally placed when in use, or are the orientations or positional relationships conventionally understood by those skilled in the art. They are only for the convenience of describing the present application and simplifying the description, and do not indicate or imply that the device or element referred to must have a specific orientation, be constructed and operated in a specific orientation, and therefore should not be understood as a limitation on the present application.

In addition, the terms “installed” and “connected” should be understood in a broad sense, for example, it can be a fixed connection, a detachable connection, or an integral connection. It can be a mechanical connection or an electrical connection. It can be a direct connection or an indirect connection through an intermediate medium, or it can be the internal communication of two components. For those skilled in the art, the specific meanings of the above terms in this application can be understood according to specific circumstances.

It should be further understood that the term “and/or” used in the specification and corresponding claims of the present application refers to any and all possible combinations of one or more of the listed items.

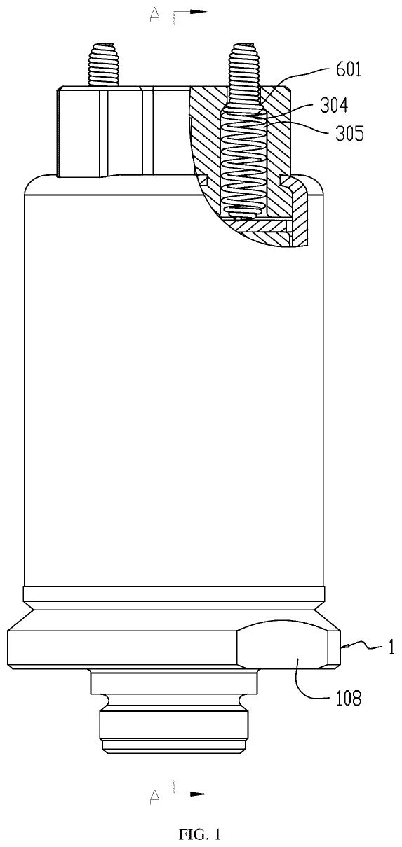

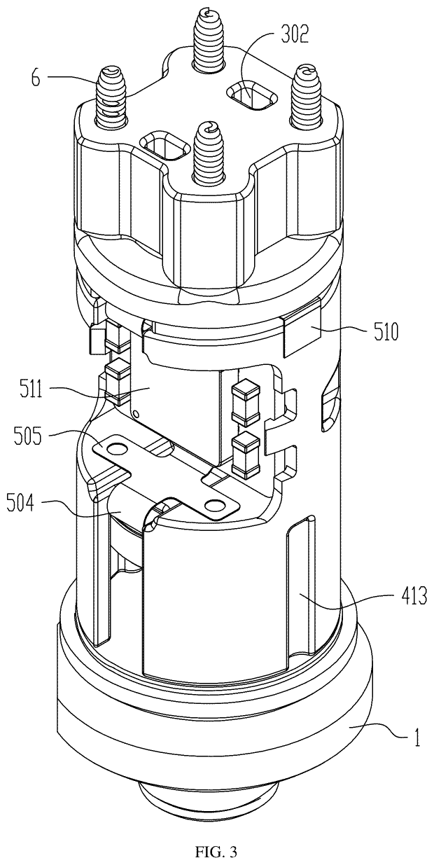

As shown in FIGS. 1 to 3, the pressure sensor of this embodiment uses such a pressure measurement assembly, which includes a pressure connector 1 and a pressure sensitive head 2. A pressure channel 100 extending longitudinally (i.e., the up and down direction in the figure) is provided in the pressure connector 1. The longitudinal distal side (i.e., the lower side in the figure) of the pressure sensitive head 2 is recessed inward to form a connecting tube 202 having a sensing cavity 203 facing the distal end, and the longitudinal proximal side of the pressure sensitive head 2 is correspondingly provided with an elastic diaphragm 204. A pressure measurement circuit is provided at the surface of the longitudinal proximal side of the elastic diaphragm 204. The proximal end of the connecting tube 202 is sealedly connected to the pressure connector 1 so that the proximal end of the pressure channel 100 is connected to the sensing cavity 203. The distal end of the pressure connector 1 is provided with a connecting pipe 101 connected to the container or pipeline to be measured. The side of the pressure connector 1 may be provided with a concave or straight circumferential positioning portion 108. In an embodiment, the above-mentioned pressure measurement circuit is composed of thick film varistors.

The proximal end of the connecting tube 202 is welded (for example, by laser welding) to the pressure connector 1. The pressure measurement assembly of this embodiment configures the pressure connector 1 and the pressure sensitive head 2 as a split structure and connects them into one by welding, thereby achieving partial isolation of the assembly stress of the pressure connector during installation.

In some other embodiments, the longitudinal proximal end and the proximal end of the pressure connector 1 are respectively extended outwardly to form a flange 106 and a support connection ring 105. The connecting tube 202 is sleeved on the flange 106 and supported and welded on the support connection ring 105. The flange 106, the support connection ring 105 and the connecting tube 202 are enclosed to form an annular cavity 107.

In this way, the collapsed welding slag can be centrally contained in the annular cavity during welding, thereby preventing the welding slag from blocking the pressure channel.

In order to facilitate the liquid to flow out of the sensing cavity when measuring the pressure of the liquid, the inner diameter of the proximal end of the pressure channel 100 can be gradually expanded to form a bell mouth 104.

In the above-mentioned embodiments, the pressure channel 100 may be formed by connecting a small-diameter section 102 at the proximal end and a large-diameter section 103 at the distal end, so that the pressure fluid can enter the sensing cavity 203 easily.

In an embodiment, the pressure sensor includes, in addition to the above-mentioned pressure measurement assembly, a housing 7, a terminal block 3, a mounting base 4 and a signal processing assembly 5. The housing 7 includes a cylindrical shell extending longitudinally and sealedly connected to the pressure connector 1 at the distal end, and an end plate 701 that blocks the longitudinal proximal end of the cylindrical shell. The terminal block 3 is fixedly connected to the end plate 701. For example, the longitudinal middle part of the terminal block 3 can form a neck 300, and the neck 300 can pass through the through hole opened on the end plate 701. The two can be firmly fixed when the terminal block 3 is injection molded. The terminal block 3, the housing 7 and the pressure connector 1 are surrounded to form a mounting cavity 400. The mounting base 4 and the signal processing assembly 5 are both provided in the mounting cavity 400. The signal processing assembly 5 is provided at the mounting base 4 and is electrically connected to the pressure measurement circuit. The signal processed by the signal processing assembly 5 is output outward through a plurality of electrical connectors 6, and one end of the electrical connector 6 is electrically connected to the signal processing assembly 5 after passing through the terminal block 3 and the end plate 701 inward. The proximal end of the terminal block 3 may be provided with a plurality of longitudinally extending first material reduction blind holes 302.

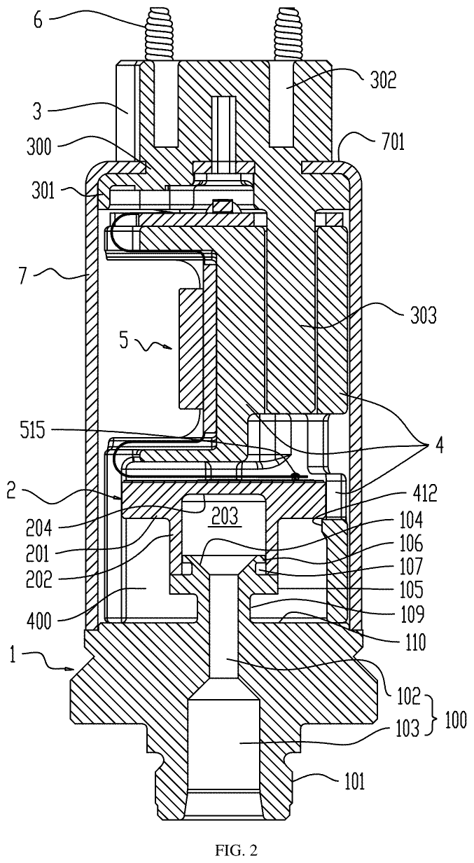

The signal processing assembly 5 may include a transverse plate 502, a first flexible plate 503, a longitudinal plate 501, a second flexible plate 504 and a first conductive connection portion 506 connected in sequence. The transverse plate 502, the longitudinal plate 501 and the first conductive connection portion 506 are arranged in sequence from near to far. The first conductive connection portion 506 and the pressure measurement circuit can be electrically connected by soldering (as shown in the solder joint 515 in FIG. 2). An electronic component 511 (such as a conditioning chip, etc.) can be provided at the longitudinal plate 501. This arrangement can control the lateral size of the pressure sensor to be very small, so that it can be easily applied to some relatively small spaces (such as some sensor centralized installation modules on cars). At the same time, it can enable the measurement circuit that must be arranged horizontally to be well and conveniently connected to the longitudinal plate 501, thereby avoiding the difficulties in the existing bonding connection process. These difficulties are manifested in that the two ends of the aluminum wire or gold wire in the bonding process should be parallel and the drop should be controlled within 1 mm, otherwise bonding can only be performed using specially customized equipment. Especially when the surfaces of the two connection points are vertical or even non-parallel, it is difficult to complete the bonding efficiently and accurately even using specially customized equipment.

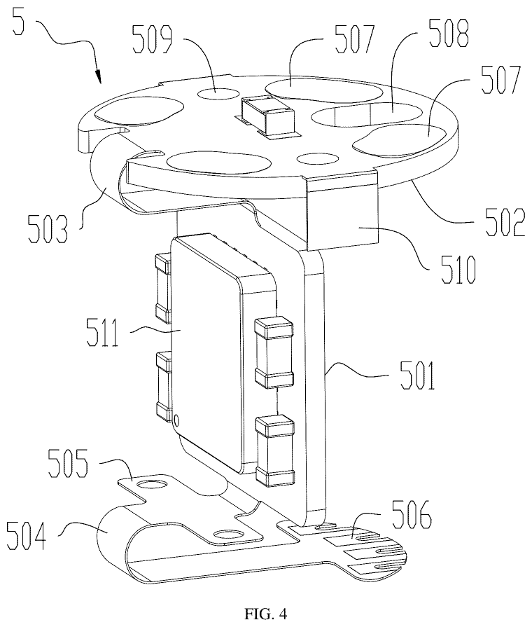

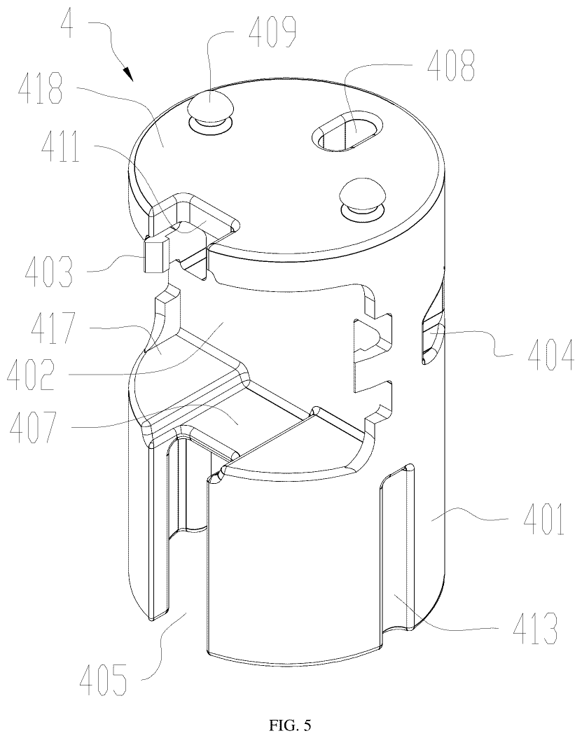

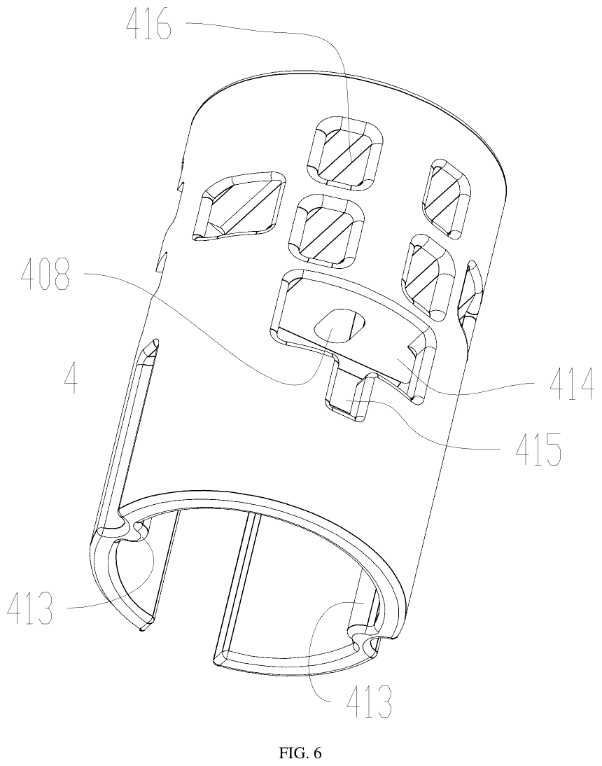

As shown in FIGS. 4 to 6, in order to reliably install the above-mentioned signal processing assembly 5, the mounting base 4 extends longitudinally and its side is recessed inward to form a receiving slot 402 for accommodating the longitudinal plate 501. A top plate 418 and a semicircular bottom plate 417 are provided opposite to each other at a proximal end and a distal end of the mounting base 4. The transverse plate 502 is supported and fixed on the proximal surface of the top plate 418. The bottom plate 417 is partially blocked at the proximal end of a pressure cylinder 401. The distal end of the pressure cylinder 401 is pressed against a support step 110 formed on the pressure connector 1. A stress isolation slot 109 is formed between the support step 110 and the support connection ring 105 to further isolate the installation stress of the pressure connector 1. At least one first buckle 403 that is clamped on the longitudinal plate 501 is provided at each of the lateral sides of the receiving slot 402, thereby avoiding the use of the glue bonding process widely used in the related art and improving production efficiency. A disassembly hole 404 extending in a parallel direction to the second flexible plate arrangement slot 407 may be provided at the side wall of the pressure cylinder 401, and the disassembly hole 404 extends to the bottom of the receiving slot 402, so as to facilitate the disassembly of the longitudinal plate 501 in the receiving slot 402. A clearance notch 405 extending to the bottom plate 417 for the second flexible plate 504 to pass through is provided at the side of the bottom plate 417. A second flexible plate arrangement slot 407 transversely in fluid communication with the clearance notch 405 is provided at the proximal side of the bottom plate 417. A plurality of second material reduction blind holes 416 may be provided at the side of the mounting base 4 facing away from the receiving slot 402.

The edge of the top plate 418 is provided with a first flexible plate arrangement slot 411 extending longitudinally and in fluid communication with the receiving slot 402 toward the distal end. The first flexible plate arrangement slot 411 and the clearance notch 405 are located at the same position in the circumferential direction of the mounting base 4. At least two rivet columns 409 are provided at the proximal end of the top plate 418. The rivet columns 409 are riveted to the corresponding rivet holes 509 opened on the transverse plate 502 toward the proximal end. In some other embodiments, the transverse plate 502 can also be fixed to the mounting base 4 by other means, for example, a circle of clamping flanges 301 formed by the distal longitudinal protrusion of the terminal block 3 is clamped on the mounting base 4 toward the distal end.

A plurality of fourth conductive connection portions 507 are provided at the proximal surface of the transverse plate 502. The electrical connector 6 is an elastic member, such as a conductive spring, and its distal end can be electrically contacted with the fourth conductive connection portion 507 after passing through the terminal block 3 and the end plate 701. In an embodiment, the electrical connector 6 is a conductive spring having two sections with different outer diameters of winding, and a conical transition section 601 is formed between the two sections. A retaining cavity 305 for accommodating the conductive spring 6 is correspondingly provided at the terminal block 3. The retaining cavity 305 is provided with a compression portion 304, and the compression portion 304 presses the distal side of the transition section 601 against the fourth conductive connection portions 507.

In some other embodiments, the terminal block 3 protrudes toward the distal end to form a guide column 303. The guide column 303 is cooperatively inserted into a guide groove 408 provided at the mounting base 4. An operating port 414 is provided at the side wall of the mounting base 4 relative to the clearance notch 405 to make room for soldering. The distal edge of the operating port 414 may be recessed toward the distal end to form a notch 415. The inner side wall of the notch 415 protrudes to form a second buckle 412 for clamping the metal base 201. In this way, the mounting base 4 and the pressure sensitive head 2 can be conveniently fixed. The pressure cylinder 401 may protrude inward or be depressed to form a circumferential positioning guide portion 413, and correspondingly, a guide groove cooperating with the circumferential positioning guide portion 413 may be formed on the metal base 201.

In some other embodiments, a third conductive connection portion 510 is provided at the side of the transverse plate 502. A second conductive connection portion 505 is provided at the side of the second flexible plate 504. The second conductive connection portion 505 is electrically connected to the metal housing 7 or the pressure connector 1 through a grounding path embedded in the mounting base 4 and then grounded. The third conductive connection portion 510 is grounded via the housing 7.

The present application is defined not by the detailed description but by the claims and their equivalents, and all variations within the scope of the claims and their equivalents are construed as being included in the present application.

What is claimed is:

1. A pressure measurement assembly, comprising:
a pressure connector provided with a pressure channel extending longitudinally; and
a pressure sensitive head;
wherein a longitudinal distal side of the pressure sensitive head is recessed inwardly to form a connecting tube, and the connecting tube is provided with a sensing cavity facing the distal end;
a longitudinal proximal side of the pressure sensitive head is correspondingly formed with an elastic diaphragm, and a pressure measurement circuit is provided at a surface of a longitudinal proximal side of the elastic diaphragm; and
a proximal end of the connecting tube is sealedly connected to the pressure connector so that a proximal end of the pressure channel is in fluid communication with the sensing cavity, and the proximal end of the connecting tube is welded to the pressure connector.

2. The pressure measurement assembly according to claim 1, wherein a longitudinal proximal end of the pressure connector is configured to protrude outward laterally to form a flange, and a proximal end portion of the pressure connector is configured to protrude outward laterally to form a support connection ring; the connecting tube is fitted on the flange and is supported and welded to the support connection ring; the flange, the support connection ring and the connecting tube are enclosed to form an annular cavity.

3. The pressure measurement assembly according to claim 1, wherein an inner diameter of the proximal end of the pressure channel is configured to gradually expand to form a trumpet-shaped bell mouth.

4. The pressure measurement assembly according to claim 1, wherein a connecting pipe is provided at a distal end of the pressure connector for connecting to a container or a pipeline to be measured.

5. The pressure measurement assembly according to claim 1, wherein a concave or straight circumferential positioning portion is provided at a side of the pressure connector.

6. A pressure sensor, comprising:
a pressure measurement assembly comprising a pressure connector and a pressure sensitive head; wherein a longitudinal distal side of the pressure sensitive head is recessed inwardly to form a connecting tube, and the connecting tube is provided with a sensing cavity facing the distal end; a longitudinal proximal side of the pressure sensitive head is correspondingly formed with an elastic diaphragm, and a pressure measurement circuit is provided at a surface of a longitudinal proximal side of the elastic diaphragm; a proximal end of the connecting tube is sealedly connected to the pressure connector so that a proximal end of the pressure channel is in fluid communication with the sensing cavity, and the proximal end of the connecting tube is welded to the pressure connector;
a housing comprising a cylindrical shell extending longitudinally and an end plate sealing a longitudinal proximal end of the cylindrical shell, wherein a distal end of the cylindrical shell is sealedly connected to the pressure connector;
a terminal block fixedly connected to the end plate, wherein the terminal block, the housing and the pressure connector are enclosed together to form a mounting cavity;
a mounting base and a signal processing assembly provided in the mounting cavity, wherein the signal processing assembly is provided at the mounting base and is electrically connected to the pressure measurement circuit; and
a plurality of electrical connectors, wherein one end of the electrical connector is configured to pass through the terminal block and the end plate inwardly and is then electrically connected to the signal processing assembly.

7. The pressure sensor according to claim 6, wherein the signal processing assembly comprises a transverse plate, a first flexible plate, a longitudinal plate, a second flexible plate and a first conductive connection portion connected in sequence; the transverse plate, the longitudinal plate and the first conductive connection portion are provided in sequence from near to far; and the first conductive connection portion is electrically connected to the pressure measurement circuit.

8. The pressure sensor according to claim 7, wherein
the mounting base is configured to extend longitudinally; a side of the mounting base is recessed inward to form a receiving slot for receiving the longitudinal plate, and a top plate and a semicircular bottom plate are provided opposite to each other at a proximal end and a distal end of the mounting base;
the transverse plate is supported and fixed at a proximal surface of the top plate, and the bottom plate is partially blocked at a proximal end of a pressure cylinder; a distal end of the pressure cylinder is pressed against a support step formed on the pressure connector; and
at least one first buckle clamped on the longitudinal plate is provided at each of lateral sides of the receiving slot.

9. The pressure sensor according to claim 8, wherein a side of the bottom plate is provided with a clearance notch extending to the bottom plate for the second flexible plate to pass through; and a second flexible plate arrangement slot is provided at a proximal side of the bottom plate and is laterally in fluid communication with the clearance notch.

10. The pressure sensor according to claim 9, wherein a disassembly hole extending in a parallel direction to the second flexible plate arrangement slot is provided at a side wall of the pressure cylinder, and the disassembly hole is configured to extend to a bottom of the receiving slot.

11. The pressure sensor according to claim 9, wherein a first flexible board arrangement slot provided at an edge of the top plate is configured to extend longitudinally and is in fluid communication with the receiving slot toward the distal end, and the first flexible board arrangement slot and the clearance notch are provided at the same position in a circumferential direction of the mounting base; and at least two rivet columns are provided at a proximal end of the top plate, and the rivet columns toward the proximal end are riveted to corresponding rivet holes opened on the transverse plate.

12. The pressure sensor according to claim 7, wherein a plurality of fourth conductive connection portions are provided on a proximal surface of the transverse plate; the electrical connector is an elastic member; a distal end of the electrical connector is passed through the terminal block and the end plate and then is configured to electrically contact the fourth conductive connection portions.

13. The pressure sensor according to claim 12, wherein the electrical connector is provided with two sections of conductive springs with different coil outer diameters, and a conical transition section is provided between the two sections of the conductive springs; a retaining cavity for accommodating the conductive springs is correspondingly provided at the terminal block, and is provided with a compression portion; and the compression portion is configured to press the transition section toward the distal side against the fourth conductive connection portion.

14. The pressure sensor according to claim 6, wherein a second buckle for clamping the metal base is provided at the mounting base.

15. The pressure sensor according to claim 8, wherein a longitudinal proximal end of the pressure connector is configured to protrude outward laterally to form a flange, and a proximal end portion of the pressure connector is configured to protrude outward laterally to form a support connection ring; the connecting tube is fitted on the flange, and is supported and welded to the support connection ring; and the flange, the support connection ring and the connecting tube are enclosed to form an annular cavity.

16. The pressure sensor according to claim 15, wherein a stress isolation slot is provided between the support step and the support connection ring.

17. The pressure sensor according to claim 6, wherein an inner diameter of the proximal end of the pressure channel is configured to gradually expand to form a trumpet-shaped bell mouth.

18. The pressure sensor according to claim 6, wherein a connecting pipe is provided at a distal end of the pressure connector for connecting to a container or a pipeline to be measured.

19. The pressure sensor according to claim 6, wherein a concave or straight circumferential positioning portion is provided at a side of the pressure connector.

20. The pressure sensor according to claim 6, wherein a proximal end of the terminal block is provided with a plurality of first material reduction blind holes extending longitudinally, and a side of the mounting base facing away from the receiving slot is provided with a plurality of second material reduction blind holes.
